(19) United States
(12) Patent Application Publication
(10) Pub. No.: US 2021/0321627 A1
(43) Pub. Date: Oct. 21, 2021

(54) NON-PESTICIDAL ATTRACT AND KILL COMPOSITION FOR CONTROL OF INSECTS

(71) Applicant: Oregon State University, Corvallis, OR (US)

(72) Inventors: Clive Kaiser, Corvallis, OR (US); Vaughn Walton, Corvallis, OR (US); Gabriella Tait, Corvallis, OR (US); Marco Valerio Rossi Stacconi, Corvallis, OR (US)

(73) Assignee: Oregon State University, Corvallis, OR (US)

(21) Appl. No.: 17/259,535

(22) PCT Filed: Jul. 10, 2019
(86) PCT No.: PCT/US2019/041230

§ 371 Date: Jan. 11, 2021

Related U.S. Application Data
(60) Provisional application No. 62/697,296, filed on Jul. 12, 2018.

(51) Int. Cl. A01N 65/34; A01N 65/06; A01N 63/14; A01N 43/78; A01N 25/00

(52) U.S. Cl. CPC A01N 65/34; A01N 65/06; A01N 25/12; A01N 43/78; A01N 25/002; A01N 63/14

(57) ABSTRACT

Insect control compositions and methods of their use in control of Drosophila suzukii damage to commercial fruit and berry crops are provided.

### CROSS-REFERENCE TO RELATED APPLICATION

This application claims the benefit of U.S. Provisional Application No. 62/697,296, filed Jul. 12, 2018, which is incorporated herein by reference in its entirety.

### FIELD OF THE INVENTION

The present invention is related to compositions and methods for control of flies of the species Drosophila suzukii.

### BACKGROUND OF THE INVENTION

Insect pests are a major source of crop damage and economic loss. Drosophila suzukii Matsumura, or spotted wing drosophila (SWD), is a new invasive pest of economically valuable berries and other soft-skinned fruits that has spread quickly from its native continent of Asia to the Americas and Europe. Reproduction of SWD involves a fertilized female searching out and landing on ripe fruit, piercing the fruit skin and inserting a serrated ovipositor, and depositing a clutch of 1 to 3 eggs per insertion. As a result, the larvae of D. suzukii feed and grow in fresh fruit, in contrast to the overripe and rotting fruits that the larvae of most other fruit-infesting Drosophila utilize.

PCT application No. WO2014031790A1 titled “Nootkatone as an Insecticide and Insect Repellent,” describes pest control compositions and, in particular, pest repellent and pesticidal compositions containing nootkatone and/or a derivative or analog thereof, alone or combination with one or more active ingredients. It further discloses arabinogalactan as a suitable and useful viscosity modulating agent for inclusion in pest repellent and pesticide compositions.

PCT application No. WO2012175639A1 titled “Arabinogalactan proteins for use as an antiparasitic agent,” describes the use of at least one arabinogalactan protein as a plant antiparasitic agent that selectively induces chemotaxis, zoospore encystment and inhibits cyst germination.

Tests carried out by Mangan and Thomas (Mangan R L and Thomas D B, Comparison of torula yeast and various grape juice products as attractants for Mexican fruit fly (Diptera: Tephritidae), J Econ Entomol. 2014 April; 107(2):591-600) compared torula yeast and various grape juice products as attractants for Mexican fruit fly.

Volatiles from Concord grape juice produced in Mexico were identified, tested for attractiveness, and mixed into an attractive blend. Volatiles were sampled with solid phase microextraction (SPME). Chemicals were analyzed by gas chromatography and identified by mass spectrometry (GC-MS). Identified chemicals were ethanol, ethyl propionate, ethyl butyrate, ethyl 2-methylbutyrate, ethyl decanoate, ethyl dodecanoate, D-limonene, sorbic acid, benzoic acid, methyl anthranilate, and dimethyl anthranilate.

In nature, the fruit fly D. melanogaster is attracted to fermenting fruit and that yeast odors represent the critical signal to establish the fly-fruit-yeast relationship. A synthetic mimic of yeast odor comprising ethanol, acetic acid, acetoin, 2-phenyl ethanol and 3-methyl-1-butanol, which were attractive for the fly, have been identified. It have been concluded that signals emitted by fruit were only of secondary importance.

It has been reported that combination baits, either a mixture of wine and yeast or a mixture of wine and a supernatant from the yeast (comboS), are significantly more attractive to D. suzukii than each alone.

DrosaLure, sold by Andermatt Biocontrol, is a commercialized attractant for SWD that comprises cider vinegar, red wine, sugar, and flavors.

Despite research into approaches to control D. suzukii, this insect pest remains a serious economic threat. New, preferably non-pesticidal, approaches for controlling SWD and thereby protecting fruits susceptible to damage are still urgently needed.

### SUMMARY

In one aspect, provided herein is a composition for control of Drosophila suzukii comprising:

(a) a cherry-derived component,

(b) arabinogalactan,

(c) thiamine, and

(d) a humectant.

In some embodiments, the arabinogalactan is larch tree arabinogalactan. In some embodiments, the cherry-derived component is freeze-dried cherry powder or fresh cherry and can comprise cherry exocarp, cherry mesocarp, or a combination thereof.

In some embodiments, the cherry-derived component in included in the composition the amount of between 0.1 wt % and about 99 wt %, between about 0.5 wt % and about 90 wt %, between about 10 wt % and about 90 wt %, %, between about 40 wt % and about 80 wt %, or between about 50 wt % and about 70 wt % on dry weight basis.

In some embodiments, arabinogalactan is included in the composition in the amount of between about 0.1 wt % and about 99 wt %, between about 5 wt % and about 80 wt %, or between about 10 wt % and about 60 wt % on dry weight basis.

In some embodiments, the composition comprises thiamine in the amount of between about 0.001 wt % and about 99 wt %, between about 0.1 wt % and about 50 wt %, or between about 0.5 wt % and about 10 wt % on dry weight basis.

In some embodiments, the humectant is hyaluronic acid, alginic acid, collagen, calcium chloride, egg white, egg yolk, gelatin, glycerol, triacetin, glycerol acetates, lecithin, pyrrolidone carbonic acid, sorbitol, xylitol, mannitol, maltitol, honey, caramelized sucrose, propylene glycol, sodium lactate, glycerin betaine, trehalose, sodium stearoyl lactate, or a combination thereof.

In some embodiments, the composition further comprises one or more components selected from collagen, beta-cyclodextrin, carrageenan, agar, calcium acetate, and calcium propionate.

In some embodiments, the composition comprises dried cherry powder, arabinogalactan, thiamine, hyaluronic acid, collagen, beta-cyclodextrin, carrageenan, agar, calcium acetate, and calcium propionate.

In some embodiments, the composition further comprises dried D. suzukii insect powder.

In some embodiments, the composition further comprises isopropyl dodecanoate, isopropyl tetradecanoate, 1,2,3-propanetriol triacetate, methyl dodecanoate, methyl tetradecanoate, myristic acid, lauric acid, or a combination thereof.

In some embodiments, the composition comprises a volatile compound component comprising methyl tetradecanoate (methyl myristate), myristic acid, lauric acid, methyl hexadecanoate (methyl palmitate), palmitic acid, palmitoleic acid, and mixtures thereof. In some embodiments, the volatile compound component comprises methyl tetradecanoate, myristic acid, lauric acid, methyl hexadecanoate, palmitic acid, and palmitoleic acid.

In some embodiments, the composition attracts male and female D. suzukii.

In some embodiments, the composition does not contain a pesticide.

In some embodiments, the composition is an aqueous composition or a dry powder. In some embodiments, the composition is a solution, a suspension, a gel, or a gum.

In another aspect, provided herein is a method of controlling D. suzukii, comprising treating an object or an area with an effective amount of a D. suzukii control composition disclosed herein.

In some embodiments, the treated area is a non-fruiting base of a plant, such as a plant member of Vaccinium spp., Rubus spp., Vitis spp., Fragaria spp., or Prunus spp. In some embodiments, the plant is a blueberry plant, huckleberry plant, raspberry plant, blackberry plant, strawberry plant, grape plant, or cherry plant.

In some embodiments of the methods disclosed herein, the treatment results in greater than about 35%, greater than about 40%, greater than about 50%, greater than about 60%, greater than about 70%, or greater than about 75% reduction in D. suzukii egg laying as determined by field oviposition trials on Elliott blueberries.

In another aspect, provided herein is a composition for control of Drosophila suzukii comprising methyl myristate, myristic acid, lauric acid, methyl palmitate, palmitic acid, and palmitoleic acid.

In some embodiments, the composition comprises from about 20 wt % to about 65 wt % palmitic acid, from about 20 wt % to about 65 wt % palmitoleic acid, from about 7 wt % to about 25 wt % myristic acid, from about 0.01 wt % to about 1.0 wt % lauric acid, from about 0.01 wt % to about 1.0 wt % methyl palmitate, and from about 0.01 wt % to about 1.0 wt % methyl myristate. In certain embodiments, the composition comprises about 43.10% palmitic acid, about 41.11% palmitoleic acid, about 14.74% myristic acid, about 0.66% lauric acid, about 0.32% methyl palmitate and about 0.07% methyl myristate by weight.

In some embodiments, the composition further comprises a food grade matrix, e.g., a matrix comprising a cherry-derived component. In some embodiments, the food grade matrix comprises arabinogalactan, thiamine, humectant, or a combination thereof. The cherry-derived component includes freeze-dried cherry powder or fresh cherry.

In some embodiments, the composition further comprises dried cherry powder, arabinogalactan, thiamine, hyaluronic acid, collagen, beta-cyclodextrin, carrageenan, agar, calcium acetate, and calcium propionate. In certain embodiments, the composition further comprises dried D. suzukii powder. In some embodiments, the composition does not contain a pesticide.

In yet another aspect, disclosed herein is a method of controlling D. suzukii, comprising treating an object or an area with an effective amount of a D. suzukii control composition disclosed herein.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-1C demonstrate D. suzukii blueberry exposure trials using 20 cm by 30 cm white organza mesh bags and covering fruit clusters containing 10-23 berries (FIG. 1A). Solid and liquid matrices were respectively trialed using ˜40 mL solid matrices within 10 cm diameter petri dishes (FIG. 1B), or by spraying 5 mL of liquid matrix on the surface of the mesh bags. Whole-bush D. suzukii exposure trials using both solid and liquid treatments were conducted by covering whole bushes using netting, which extended to the soil surface (FIG. 1C).

FIG. 2 is the number of D. suzukii flies selecting deli cups containing exemplary composition compared to flies selecting deionized water under controlled laboratory conditions within ventilated choice arenas.

FIG. 3 shows D. suzukii egg-laying in five fruit types in choice tests under controlled conditions in the laboratory. Control treatments only contained fruit. Treated fruit additionally contained liquid matrices in a separate cup ˜10 cm away from the fruit. The liquid matrix had an approximate similar surface area as the fruit.

FIGS. 4A and 4B demonstrate effect of solid (FIG. 4A) and liquid matrices (FIG. 4B) on D. suzukii egg laying in fruit within mesh bags on eleven-year-old drip irrigated ‘Elliot’ blueberry in Corvallis, Oreg. Bars with an asterisk indicate a significant reduction in egg laying.

FIGS. 5A and 5B demonstrate effect of solid (FIG. 5A) and liquid matrices (FIG. 5B) on D. suzukii egg laying in fruit on whole plants on eleven-year-old drip irrigated ‘Elliott’ blueberry in Corvallis, Oreg. Bars with an asterisk indicate a significant reduction in egg laying.

FIG. 6 is a graph of minimum (x) and maximum (•) temperatures and precipitation during the experimental period on ‘Elliott’ blueberry in Corvallis, Oreg. Arrows indicate the days during which field experiments were initiated.

FIG. 7 is a GC/MS chromatogram of volatile extracts of an exemplary insect control composition. On the top are reported the retention times (RT) of the components.

### DETAILED DESCRIPTION

The applicants of the present disclosure identified a need for better methods of controlling insect infestation of plants and fruits susceptible to insect damage. To that end, the applicants of this disclosure have identified various insect control compositions that are useful in protecting susceptible plants or fruits from insect damage.

The various embodiments and examples described herein rely, at least in part, on the discovery insect control compositions can provide volatile chemical attractants that can affect insect behavior, including insect association with susceptible plants or fruits, and egg laying into susceptible fruits. Surprisingly, the inventors discovered that inclusion of arabinogalactan, a viscosity-modifying agent in some insect repellents, can, when formulated according to certain embodiments described herein, render the compositions into an insect attractant. The inventors further discovered that the attractive character of the formulations is, at least in part, due to the production of chemical volatiles described herein and that may act as attractants. Thus, the present disclosure provides a variety of insect control agents, including agents that give rise to chemical attractants or are chemical attractants, or combinations of both. Also provided are methods of making and using such insect control agents.

### Insect Control Compositions

In one aspect, disclosed herein are compositions for control of Drosophila suzukii. In some embodiments, the compositions comprise:

(a) a fruit-derived component such as cherry-derived component,

(b) arabinogalactan,

(c) thiamine, and

(d) a humectant.

As used herein, arabinogalactan is a biopolymer consisting of arabinose and galactose monosaccharides. Particularly suitable arabinogalactans include plant-derived arabinogalactans, such as arabinogalactans originating from the larch tree. In some embodiments, the compositions comprise arabinogalactan in the amount of between about 0.1 wt % and about 99 wt %, between about 5 wt % and about 80 wt %, or between about 10 wt % and about 60 wt % on dry weight basis.

Any suitable cherry-derived component can be used in the compositions of the disclosure. In some embodiments, the cherry-derived component comprises dried cherry powder. In some embodiments, the cherry-derived component comprises fresh sweet cherry; freeze-dried powdered sweet cherry, fresh sour cherry, or a combination thereof. Cherry includes sweet and sour cherries of any suitable variety, such as but not limited to such common commercial varieties of cherries as ‘Sweetheart’ and ‘Bing.’ In the embodiments of the compositions comprising sour cherries, the cherry-derived component can also comprises supplemental sugars. Supplemental sugars can be included in the sour cherry-derived component in any suitable ratio, e.g., glucose and fructose at ˜45-48% each, with sucrose, glucose or fructose or a combination thereof making up the balance. Any combination of exocarp and mesocarp of the above described cherry fruit can be used in the insect control compositions disclosed herein.

In some embodiments, the cherry-derived component comprises dried cherry powder and is included in the compositions in the amount of between about 0.1 wt % and about 99 wt % on dry weight basis. In other embodiments, the cherry-derived component is included in the amounts between about 0.5 wt % and about 90 wt % on dry weight basis. In some embodiments, cherry-derived component is included in the amounts between about 0.1 wt % to about 60 wt % in relation to the percentage of the other ingredients.

In some embodiments, the composition comprises cherry-derived component in the amount of between 0.1 wt % and about 99 wt %, between about 0.5 wt % and about 90 wt %, between about 10 wt % and about 90 wt %, between about 40 wt % and about 80 wt %, or between about 50 wt % and about 70 wt % on dry weight basis

The insect control compositions disclosed herein comprise thiamine. Typically, thiamine is included in the compositions in the amount of between about 0.001 wt % and about 99 wt %, between about 0.1 wt % and about 50 wt %, or between about 0.5 wt % and about 10 wt % on dry weight basis. In some embodiments, the compositions comprise about 5 wt %, about 6 wt %, or about 7 wt % of thiamine on a dry weight basis.

The insect control compositions disclosed herein further comprise one or more humectants. In some embodiments, the humectant is hyaluronic acid. Preferably, the humectants are food-grade humectants. Suitable humectants include hyaluronic acid, alginic acid, collagen, calcium chloride, egg white, egg yolk, gelatin, glycerol, triacetin, glycerol acetates, lecithin, pyrrolidone carbonic acid, sorbitol, xylitol, mannitol, maltitol, honey, caramelized sucrose, propylene glycol, sodium lactate, glycerin betaine, trehalose, sodium stearoyl lactate, and combinations thereof. In certain embodiments, non-food grade humectants such as super absorbents, e.g., Stockosorb 660, can be included in the insect control compositions.

In some embodiments, insect control compositions of the present disclosure comprise a freeze-dried powdered D. suzukii. For example, insect control compositions of this disclosure can comprise freeze-dried powdered D. suzukii in the amount from about 0.0001% to about 5%, or from about 0.01% to about 0.1%, or about 0.05%, on dry weight basis (wv %).

In some embodiments, the insect control compositions further comprise one or more additional components. Various components such as collagen, beta-cyclodextrin, carrageenan (including but not limited to iota carrageenan and kappa carrageenan), agar, calcium acetate, and calcium propionate can be included in the insect control compositions.

In some embodiments, the insect control compositions disclosed herein comprise a preservative component. Examples of suitable preservative components include fumaric acid, iron calcium acetate, sodium lactate, ethylenediaminetetraacetic acid, iron III monosodium salt powder, erythorbic acid, erythritol, sorbitol, calcium acetate, calcium propionate, and/or potassium sorbate. In some embodiments, the compositions comprise calcium acetate. In some embodiments, compositions comprise compounds which are classified as Inert Ingredients Eligible for FIFRA 25(b) Pesticide Products, as listed by the U.S. Environmental Protection Agency. In some embodiments, these compounds are included in the amounts effective to serve as a preservative component. In some embodiments, inclusion of a preservative component such as calcium acetate also results in mortality of flies, without loss of attractancy.

In some embodiments, insect control compositions of the present disclosure comprise a superabsorbent component. Examples of superabsorbent components include superabsorbent polymers (sometimes referred to as slush powder). As used herein, superabsorbent polymers are water-absorbing polymers that can absorb and retain large amounts of liquid relative to their own mass. In some embodiments, the superabsorbent component is a hydrogel. Hydrogel, as used in this context, means a cross-linked water-absorbing polymer. One example of a superabsorbent polymer is a potassium polyacrylamide/acrylate copolymer, which is listed as the active ingredient in the commercially available product Terra-Sorb® that is manufactured by Lebanon Seaboard Corporation.

In an exemplary embodiment, the insect control composition comprises dried cherry powder, arabinogalactan, thiamine, hyaluronic acid, collagen, beta-cyclodextrin, agar, and a calcium salt selected from calcium acetate, calcium propionate, or a combination thereof. For example, in one illustrative embodiment, the composition comprises the following components in the amounts on dry basis:

Cherry powder: 59.4 wt %;

Arabinogalactan: 14.8 wt %;

Collagen: 4.95 wt %;

Calcium propionate and/or calcium acetate: 0.99% wt;

Beta-cyclodextrin: 9.9 wt %;

Agar: 4.95 wt %;

Freeze-dried powdered D. suzukii: 0.05% and

Hyaluronic acid: 4.95%.

The compositions disclosed herein include both dry powders and formulations comprising added water, such as solutions, suspensions, and gums. In some embodiments, water can be present in and/or added to the insect control compositions. Typically, water can be present in the amounts between about 0.1 wv % and about 99 wv %, between about 60 wv % and about 95 wv %, or between is about 65 wv % and about 95 wv %.

In some embodiments, the insect control compositions further comprise freeze-dried D. suzukii insect powder at about 0.05 wv %, or between 0.0001 wv % and about 5 wv %, or between about 0.01 and about 1 wv %.

In some embodiments, insect control compositions of the present disclosure are based, at least in part, on the discovery of certain volatile products or chemicals that act as insect pest attractants. The terms “insect control composition” and “insect control agent” are used interchangeably throughout the disclosure. In some embodiments, insect control agents of the present disclosure comprise a volatile chemical attractant. In other embodiments, insect control agents of the present disclosure comprise precursors of volatile insect attractants. For example, insect control agents of the present disclosure can comprise components that react to form esterified products that act as insect control agents, for example, such esterified products can act as insect attractants.

Without wishing to be bound by theory, it is believed that in certain embodiments, fatty acids derived from fruit components of insect control agents of the present disclosure can react with alcohols that arise from the fermentation of certain components to give rise to esterified products. Without limiting the invention, the applicants believe that at least some of the esterified products are insect attractants that alter insect behavior.

In some embodiments, the compositions disclosed herein comprise isopropyl dodecanoate, isopropyl tetradecanoate, 1,2,3-propanetriol triacetate, methyl dodecanoate, methyl tetradecanoate, or a combination thereof. These esters can be produced in the compositions as described above or, in some embodiments, an effective amount of one or more of the substantially purified esters, such as isopropyl dodecanoate, isopropyl tetradecanoate, 1,2,3-propanetriol triacetate, methyl dodecanoate, methyl tetradecanoate, or a combination thereof, can be added to the insect control compositions to achieve a desired effect, such as attracting insect pests away from plants or fruits susceptible to insect pest damage. In some embodiments, the insect control agents or compositions comprise a volatile compound component comprising palmitic acid, palmitoleic acid, myristic acid, lauric acid, methyl palmitate, and methyl myristate. The volatile compound component can be in the form of a mixture of synthetic compounds described herein and added to the insect control compositions to achieve a desired effect, such as attracting insect pests away from plants or fruits susceptible to insect pest damage. In some embodiments, the volatile compound component or a part thereof can form spontaneously in the compositions disclosed herein as described above.

In some embodiments, insect control agents of the present disclosure comprise a chemical volatile capable of altering at least one behavior of an insect pest. In some embodiments, the chemical volatile comprises palmitic acid, palmitoleic acid, myristic acid, lauric acid, methyl palmitate, and methyl myristate. For example, insect control agents of the present disclosure can comprise insect attractants that attract insect pests. When used in proximity to a plant or fruit susceptible to insect pest damage, insect control agents of the present disclosure can achieve reduced insect pest interaction with the susceptible plant or fruit. In another example, insect control agents of the present disclosure serve as an alternative egg laying site for insect egg laying and reduce egg laying behavior into plants or fruits susceptible to insect pest damage or infestation associated with egg laying. In some embodiments, insect control agents of the present disclosure comprise an insect attractant and also provide an alternative egg laying site, thus luring insect pests away from susceptible fruit and reducing the overall viability of insect pests.

In some embodiments, the insect control compositions of the present disclosure comprise a desiccant or drying agent that kills or inhibits the development or growth of insect pests, insect pest eggs, or insect larvae.

In some embodiments, the insect control compositions of the present disclosure do not contain a pesticide, such as synthetic pesticide. In some embodiments, the compositions disclosed herein are substantially pesticide-free.

Insect control compositions of the present disclosure can achieve D. suzukii control in one or more ways. In some embodiments, insect control can be achieved by influencing behavior of an insect, e.g., D. suzukii. For example, the insect control composition can act as an attractant and draw D. suzukii away from susceptible plants, crops, or fruit.

In some embodiments, the insect control composition acts as a matrix for or an alternative egg laying site, such that D. suzukii not only land on and physically associate with the insect control composition, but also lay eggs on or into the insect control agent. In some embodiments, a “matrix” generally refers to the physical state of a mixture of ingredients, such as the insect control compositions disclosed herein. This term encompasses gel, liquid, and solid formulations of the insect control compositions of the invention. As used herein, the terms “composition” and “matrix” can be used interchangeably. By acting as an alternative egg laying site, it is reasonable to expect insect control compositions of the present disclosure to reduce egg laying in insect damage susceptible fruit.

The insect control compositions embodiments described herein can be prepared by any suitable means, for example, by mixing together dry powders of the components such as cherry fruit, calcium propionate, collagen, beta-cyclodextrin, carrageenan, arabinogalactan, agar, hyaluronic acid, thiamine, and calcium acetate to provide a dry powder mixture. In some embodiments, the composition can be prepared by (a) preparing a fruit puree comprising fruit skin (exocarp) and flesh (mesocarp); and (b) adding a powder mixture comprising the remaining ingredients to the puree. Water can be optionally added to the compositions disclosed herein, and then the composition can be mixed until the powders are substantially dissolved to provide a mixed flowable solution or matrix.

The present disclosure also provides insect control agents that give rise to or comprise attractant volatiles. In some embodiments, the attractant volatiles described herein are substantially purified and capable of acting as an insect control agent.

In another aspect, the disclosure provides a composition for control of Drosophila suzukii comprising a volatile compound component comprising methyl myristate, myristic acid, lauric acid, methyl palmitate, palmitic acid, and palmitoleic acid.

In some embodiments, the volatile compound component comprises from about 20 wt % to about 65 wt % palmitic acid, from about 20 wt % to about 65 wt % palmitoleic acid, from about 7 wt % to about 25 wt % myristic acid, from about 0.01 wt % to about 1.0 wt % lauric acid, from about 0.01 wt % to about 1.0 wt % methyl palmitate, and from about 0.01 wt % to about 1.0 wt % methyl myristate. In other embodiments, the composition comprises about 40% palmitic acid, about 40 wt % palmitoleic acid, about 15 wt % myristic acid, about 1.0 wt % lauric acid, about 0.5 wt % methyl palmitate and about 0.1 wt % methyl myristate relative to the weight of the volatile component. In certain embodiments, the composition comprises about 43.10 wt % palmitic acid, about 41.11 wt % palmitoleic acid, about 14.74 wt % myristic acid, about 0.66 wt % lauric acid, about 0.32 wt % methyl palmitate and about 0.07 wt % methyl myristate relative to the weight of the volatile component.

In some embodiments, the compositions further comprise a matrix, e.g., food grade matrix. Any suitable matrix can be used in the preparation of the compositions for control of Drosophila suzukii disclosed herein. For example, in some embodiments, the food-grade matrix comprises a cherry-derived component, for example, freeze-dried cherry powder or fresh cherry as described above. In some embodiments, the food grade matrix further comprises arabinogalactan, thiamine, humectant, or a combination thereof.

In some embodiments, in addition to the volatile compound component described above, the composition further comprises dried cherry powder, arabinogalactan, thiamine, hyaluronic acid, collagen, beta-cyclodextrin, carrageenan, agar, calcium acetate, and calcium propionate.

In certain embodiments, the composition further comprises dried D. suzukii powder. Preferably, the compositions do not contain a pesticide, such as synthetic pesticide. In some embodiments, the compositions disclosed herein are substantially pesticide-free.

Methods of Insect Control

In yet another aspect, disclosed herein is a method of controlling D. suzukii, comprising treating an object or an area with an effective amount of a D. suzukii control composition as disclosed herein. In some embodiments, treatment includes application of one or more compositions disclosed herein to an area of a plant, for example, a non-fruiting base of a plant.

The methods of D. suzukii control disclosed herein can be used to control D. suzukii-caused damage and to treat various plants of commercial importance, for example, plant members of Vaccinium spp., e. g. blueberry, huckleberry; Rubus spp., e.g. raspberry, blackberry, Vitis spp., e. g. grape; Fragaria spp., e. g. strawberry, and/or Prunus spp. e. g. cherry. The trial data disclosed herein indicates that commercially available cultivars within these plant species resulted in favorable management. For insect control, the compositions disclosed herein can be used in any suitable physical state or formulation, including but not limited to gels, gums, powders, and solutions. In certain embodiments, the methods use solid matrix compositions. For some applications, powder-based compositions can be directly applied to the ground. Due to the capacity of the super-absorbent components or humectants to absorb air moisture, attractant substrate can be formed form dry powder directly applied to the ground.

In some embodiments, the treatment results in greater than about 35%, about 40%, about 50%, about 60%, about 70% or about 75% reduction in D. suzukii egg laying as determined by oviposition trials conducted on Elliott blueberries.

In another aspect, disclosed herein is a method of controlling D. suzukii, comprising treating an object or an area with an effective amount of a D. suzukii control composition, wherein the composition comprises a volatile compound component comprising methyl myristate, myristic acid, lauric acid, methyl palmitate, palmitic acid, and palmitoleic acid.

The compositions disclosed herein provide an alternative approach to the management of D. suzukii egg-laying behavior using a novel behavioral manipulation treatment. The inventors demonstrated significant reductions of egg-laying on blueberries, cherries, strawberries, raspberries and blackberries under controlled laboratory conditions, as demonstrated by the examples.

In certain embodiments, in the field experiments that were carried out on blueberry clusters, each containing a predetermined number of D. suzukii. In some embodiment, egg-laying by D. suzukii was reduced by greater than about 35%, about 40%, about 50%, about 60%, about 70%, or about 75%. In some instances, as shown in the examples, egg-laying was significantly reduced on 8 out of 9 experimental dates, using both solid and liquid exemplary composition formulations (also referred to as matrices) over periods of 72 to 96±2 hours. In whole-bush field experiments, exposing fruit to D. suzukii populations over 3-4 days included the location within the experimental bush as an additional factor in the experimental design. Here, oviposition was significantly reduced on all 5 of the experimental dates. The location on the bush had the largest impact on the reduction of egg-laying, with the largest reductions occurring in the middle and lower portions of the blueberry bush. Overall, the reduction of the absolute number of eggs and the number of infested berries was largely similar. In all cases, when egg-laying was reduced, there was also a reduction in the number of infested berries.

In some embodiments, data were collected under varying environmental conditions over a 2-month period for the field experiments on blueberry. Considering weather conditions, it appeared as if egg-laying was higher under conditions where temperatures were above 20° C. and below 30° C.; however, it appeared that temperature, humidity and rainfall had minimal overall impact on the efficacy of the applied treatments. Finally, the data generated from the EAG trials indicate a similar response of D. suzukii in both the Italian and Oregon populations of D. suzukii using volatiles originating from Arabinogalactan and the other ingredients within the composition (e.g., volatiles such as myristic acid, lauric acid, palmitoleic acid, palmitic acid, isopropyl dodecanoate, isopropyl tetradecanoate, 1,2,3-propanetriol triacetate, methyl tetradecanoate (methyl myristate), methyl hexadecanoate (methyl palmitate), and methyl dodecanoate). Subsequent experiments conducted under controlled laboratory conditions showed significant attraction to these key volatiles identified in the GC-MS and EAG electrophysiology trials.

The fact that the matrices preparation consistently resulted in significant reductions of D. suzukii damage on fruit provides a strong impetus of future commercial implementation. Research on the control of D. suzukii has predominantly focused on attractants. Alternative methods looked at the use of sugar, a phagostimulant mixed with pesticides and sprayed on the canopy to improve efficacy of insecticides. Push-pull strategies proposing aversive and attractive stimuli in order to modify D. suzukii pest distribution in the crop resulted in encouraging results.

The insect control compositions disclosed herein for D. suzukii control show significant reductions of fruit infestation over relatively extended periods. Without wishing to be bound by theory, it is possible that these reductions are the result of altered egg-laying behavior toward susceptible fruit. The data indicates a strong, consistent, and competitive attraction of the matrix when presented together with berries. The data demonstrates that D. suzukii crop damage can be reduced by using attractive volatiles in commercial field settings.

In some embodiments, the composition as tested contains no conventional insecticides and provides an alternative and environmentally friendly management tool for D. suzukii. Since D. suzukii has become an economically important pest in both Americas and Europe, the number of tools and techniques to manage D. suzukii commercially has increased. Currently, several trap designs, synthetic volatiles, and different types of baits are available, aiding in the control of this important pest. It is acknowledged that the currently available tools have many limitations. Moreover, the prevailing problem with synthetic volatile compositions is that they do not mimic natural circumstances. Even with all available options, effective management of the pest is a challenge and requires a more efficient method of control.

In some embodiments, the compositions disclosed herein manipulate pest behavior. In addition to being an alternative ovipositional medium, in some embodiments, the compositions can be providing D. suzukii a substrate where several additional activities of biological significance may be observed, including but not limited to feeding and mating. These findings support the use of the compositions as a biologically-based product to handle problematic D. suzukii infestations in an environmental friendly way.

In some embodiments, the insect control methods using the insect control compositions disclosed herein can be paired with additional approaches available in an IPM program. In some embodiments, the compositions disclosed herein are water-soluble on account of their organic composition and can be applied without limitations of time or quantity. In some embodiments, a consistent application of the compositions can be particularly useful during the late dormant period, and when fly activity increases, because during these two key bottleneck periods of the year, few ovipositional sites and limited food sources are available, with the exception of berries on secondary plant species including Hedera helix and Viscum album L. berries during winter/early spring, and Sarcococca species. Thus, in some embodiments, the compositions disclosed herein provide D. suzukii flies with an alternative substrate for oviposition that can reduce the chances of infestation of early-ripening susceptible commercial fruits at the beginning of the growing season. Moreover, in some embodiments, the compositions have a dehydrating effect and a thus kill larva, providing a constant reduction of the fly population.

In some embodiments of the insect control methods disclosed herein, the compositions provide an alternative to conventional control techniques and are not directly applied onto fruit, thus resulting in the opportunity of reductions of pesticide residues. In some embodiments, the compositions can also be applied during any time of year. In some embodiments, the compositions can be applied in the border areas where the surrounding vegetation offers refuge to the pest. In some embodiments, the compositions act as a lure to attract both females and males of D. suzukii and to induce females to lay eggs on the composition.

As used herein, the term “about” indicates that the subject value can be modified by plus or minus 5% and still fall within the disclosed embodiment.

While each of the elements of the present disclosure is described herein as containing multiple embodiments, it should be understood that, unless indicated otherwise, each of the embodiments of a given element of the present invention is capable of being used with each of the embodiments of the other elements of the present invention and each such use is intended to form a distinct embodiment of the present invention.

The referenced patents, patent applications, and scientific literature referred to herein are hereby incorporated by reference in their entirety as if each individual publication, patent or patent application were specifically and individually indicated to be incorporated by reference.

As can be appreciated from the disclosure above, the present invention has a wide variety of applications. The invention is further illustrated by the following examples, which are only illustrative and are not intended to limit the definition and scope of the invention in any way.

### Examples

1. Preparation of Exemplary Insect Control Compositions

Two exemplary insect control compositions (also referred to as matrices), liquid and solid, were prepared according to Table 1.

TABLE 1
Composition (% wt) of two exemplary D. suzukii compositions
used in the field trials as described below.

| | RATIOS | |
|---|---|---|
| INGREDIENTS | Liquid matrix (%) | Solid matrix (%) |
| Cherry | 6.00 | 19.93 |
| Arabinogalactan | 1.50 | 4.98 |
| Collagen | 0.50 | 1.66 |
| Hyaluronic acid | 0.50 | 1.66 |
| Thiamine | 0.5 | 1.66 |
| Agar | 0.5 | 1.66 |
| Beta-cyclodextrin | 1.00 | 3.32 |
| Calcium acetate | 0.10 | 0.33 |
| D. suzukii freeze-dried | 0.05 | 0.17 |
| powder | | |
| Water | 89.35 | 64.79 |
| TOTAL | 100 | 100 |

2. Laboratory and Field Testing of Insect Control Compositions

In embodiments, insect control agents of the present disclosure can be applied to plants or fruits that are susceptible to insect damage. For example, approximately 100 g of a flowable solution may be applied to the non-fruiting base of a blueberry bush in the field.

2.1 Materials and Methods

2.1.1 Insects

D. suzukii used for the laboratory and field trials were direct offspring of individuals collected in Oregon (Willamette Valley, 44° 55′58.2″N, 123° 03′50.6″W, USA) in 2009. A second D. suzukii population originating from individuals collected in northern Italy (Trentino Province, 46° 04′24.3″N, 11° 07′17.2″E) was used for GC-EAD experiments in addition to Oregon D. suzukii. Laboratory colonies from both geographic locations were regularly supplemented with locally collected flies to prevent inbreeding. Flies were reared in a 24×24 cm cage (Bugdorm-1, MegaView Science Co., Ltd., Taichung, Taiwan) and provided with a water wick and an artificial corneal diet that served as both an oviposition medium and food source. Insects were maintained in the laboratory at 22° C., 65% RH and a photoperiod of 8:16 h (light:dark). In all tests, D. suzukii were ca. 8 days old and previously mated.

2.1.2 Laboratory Choice Assays

Constant and uniform airflow was created within each of the containers using a vacuum at 1.5 L mid′ from the base and through the upper portion of each of the respective containers. Attraction to the matrix containing the ingredients of the exemplary insect control composition was verified in double-choice behavioral experiments. Arenas were prepared using 2-L transparent Griffin-style graduated low-form plastic beakers (Nalgene, Rochester, N.Y.). For each beaker, 9 ventilation holes (1 cm diameter) were cut along the circumference approximately 6 cm from the base. The holes were covered with fine white mesh in order to prevent D. suzukii individuals from escaping. The top of each beaker was drilled and connected to a 0.5 cm diameter plastic tube providing a vacuum in order to create a constant and uniform air flow (1.5 L min⁻¹) within the containers. Beakers were placed upside down on a flat work surface covered by white paper sheets. Two 25 mL plastic cups (Dart Container Corporation, Mason, Mich.) containing ˜10 mL of water and 5 g of arabinogalactan were placed at the base of each beaker. Both cups were covered with a wax film (Parafilm® M, Pechiney, Chicago, Ill.). 3 holes (˜0.3 cm diameter) were cut on the film coverings in order to allow the flies to enter the cups. Twenty mated females and males were released within each arena, allowing them to orient and eventually enter the cups. After 24 h, the number of D. suzukii caught within each cup was counted, as well as flies that did not make any choice.

2.1.3 Oviposition Tests

The ingredients of the exemplary insect control composition were mixed at a 1.5% rate under laboratory conditions at 22° C., 65% RH. The matrices were created in two forms: solid and liquid. The solid matrix contained 84% water, while the liquid matrix contained 89% water. The resultant matrices were used for D. suzukii efficacy trials within 1-2 hours of preparation in both laboratory experiments and field trials. In addition, the inventors tested a refined matrix containing 0.05% freeze-dried D. suzukii powder, against the original recipe to determine increased efficacy (reduced egg laying in fruit). These experiments were conducted using 32 replicates in the containers described above, and using the same protocols as above. Here, the reduction in D. suzukii oviposition was determined for both treatments on blueberry.

2.1.4 Laboratory Oviposition Experiments

Experiments were performed on blackberries, blueberries, cherries, strawberries, and raspberries under controlled conditions. Ventilated arenas were prepared as described for the double-choice experiments. Two 25-ml Deli cups (Dart Container Corporation, Mason, Mich.) were placed inside each arena, one containing ca. 6±0.1 g of the solid matrix, and the other containing fresh fruit in treated repetitions. The control treatments only contained fruit. For each fruit type, an approximate surface area of 32 mm² was exposed, corresponding to the exposed area of the matrix within the Deli cup in the treated repetitions. 15 D. suzukii individuals, 10 females and 5 males, were released into each arena. After 24 h, the number of eggs laid on the berries and into the matrix was counted. The experiment for each fruit type was replicated ten times.

2.1.5 Field Oviposition Trials

Oviposition trials were conducted from 8 August to 17 Oct. 2017 at the Lewis-Brown Farm at Oregon State University (44° 33′13″N 123° 13′07″W) in an organic 11-year-old drip irrigated cv. Elliott blueberry field. Plants were spaced approximately 0.76 m apart within rows with 3.05 m between rows and were not treated with insecticides. The width and height of plants were approximately 1 m and 1.5 m, respectively. Two drip irrigation lines, one on either side of the blueberry plant, were placed under sawdust mulch cover within standard raised beds (Bryla et al., 2011) and provided irrigation at levels of 100% (255±5 mm H₂O per growing season), of the estimated crop evapotranspiration (ET_{c}) requirement (Bryla et al., 2011).

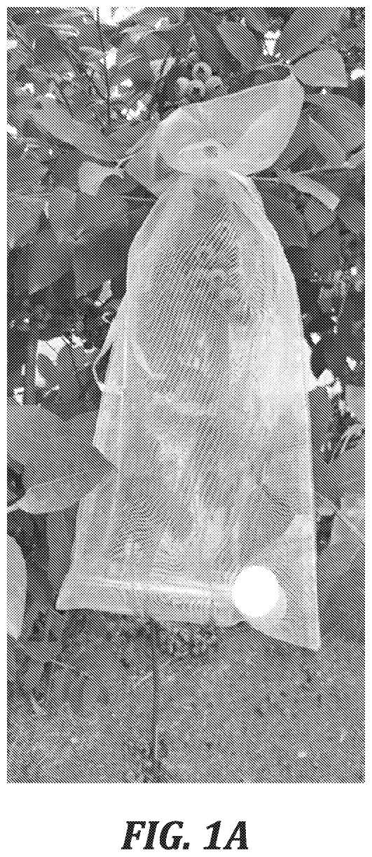

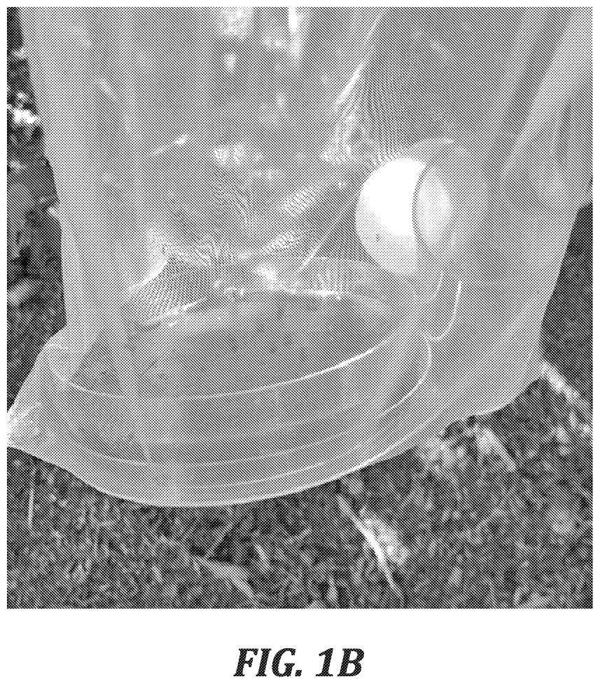

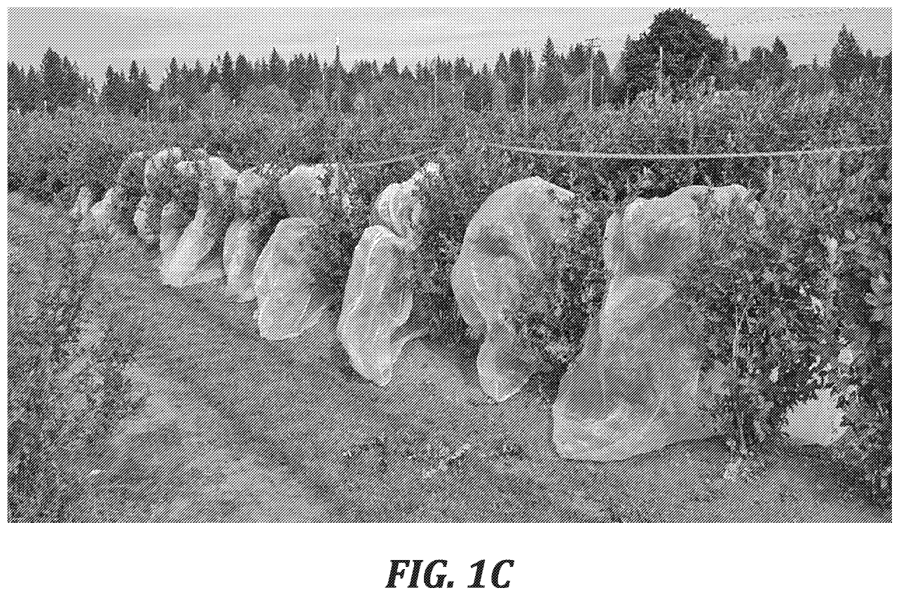

Two series of trials were performed. In the first, single fruit clusters were isolated in mesh bags, while the second trial was carried out using isolated whole bushes. Field oviposition trials including fruit were conducted by covering fruit clusters (10-23 berries) with 20 cm×30 cm white organza mesh bags (Uline, Pleasant Prairie, Wis.). All mesh bags were placed approximately 1 mm apart on the north side of the bush within the shade of the canopy and 0.2 to 1.3 m above ground level. Each mesh bag contained ten D. suzukii adults, 5 females and 5 males. Either solid or liquid matrices were added to the treatment mesh bags. Solid matrix was trialed using 40±0.5 mL contained within 10 cm diameter petri dishes (FIG. 1A) on 8 and 31 August; 13, 15 and 25 September; and 11 Oct. 2017. Liquid matrix was applied by spraying 5 mL on the surface of the mesh bags using an all-purpose spray bottle (Home Depot, Atlanta, Ga., FIG. 1B) on 13 September, 15 September, and 11 Oct. 2017. Every trial date contained ten replicates for treated and control clusters each. All trials were started between 3 and 5 pm and were collected 72±2 hours later to determine the levels of oviposition on fruits and within the matrix. All damaged berries were excluded when assessing the egg-laying levels in the laboratory under a dissecting microscope. Experiments based on these treatments were replicated 10 times on each of the treatment dates and were conducted on 10 separate days.

Whole-bush D. suzukii exposure trials using both solid and liquid matrices were conducted in order to determine efficacy when the matrix is applied at the base of the bush. Entire bushes were covered using 80 g Tek-Knit netting (Berry Protection Solutions, Stephentown, N.Y.) which extended to the soil surface (FIG. 1C). In total, 100 D. suzukii (50 females and 50 males) were released within each netted bush. Solid and liquid matrices were respectively trialed using 100±2 mL solid matrix placed within five 10 cm diameter petri dishes, or by spraying 100±2 mL of liquid at the base of the bush on a 15×30 cm microfiber cloth (Costco, Kirkland, Wash.). Replicates of both treated and control plants were exposed between 3 pm and 5 pm and fruit were collected 72±2 to 96±2 hours after initial placement of flies. Solid matrix experiments were replicated twice, i.e. on 22 and 24 Sep. 2017. Liquid matrix experiments were repeated three times, i.e. on 27 September, 3 October and 9 Oct. 2017. On each date, 5 replicates (bushes) per treatment were set. After the D. suzukii exposure period, 20 firm berries were collected from each area of the plant, designated as the top (˜1.3 m above soil level), middle (˜0.8 m above soil level) and bottom (˜0.3 m above soil level) for a total of 60 berries collected per bush. Assessments of oviposition were determined by calculating the number of eggs laid per berry and percent of infested berries.

2.1.6 Weather Data

Weather data including temperature (° C.), humidity (%) and rainfall (mm) were obtained from the Corvallis, Oreg. Agrimet weather site (Oregon State University Hyslop Farm 44° 38′03″ N 123° 11′24″ W). In this way it was possible to verify daily the weather conditions during the field trials. https://www.usbr.gov/pn/agrimet/agrimetmap/crvoda.html.

2.1.7 Statistical Analysis

Data from laboratory double-choice experiments and oviposition trials were analyzed using one-way Anova, and the Tukey's test was applied to separate difference at α<0.05. Field trials data were analyzed using one-way ANOVA tests. Differences in volatile perception between Oregon and Italian D. suzukii were tested with the Mann-Whitney U-test (Mann and Whitney, 1947). All analyses were run using Statistica 64©12 (StatSoft Inc., Tulsa, Okla.; Hill and Lewicki, 2007).

2.2 Results

2.2.1 Laboratory Choice Assays

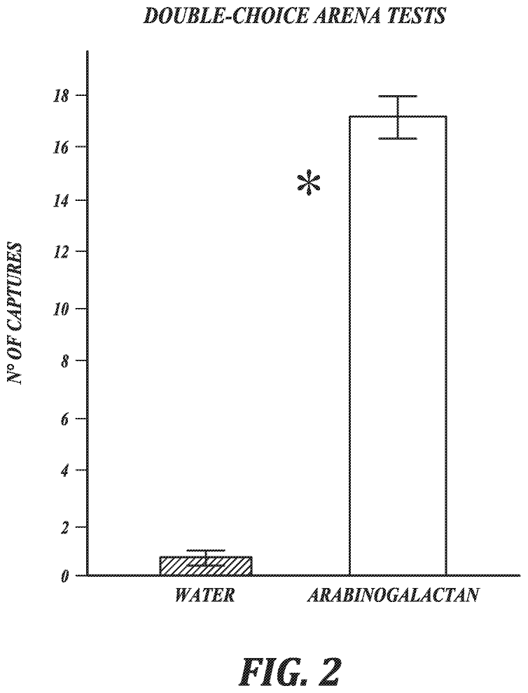

The number of flies selecting deli cups containing arabinogalactan was significantly higher (F_{2, 33}=188.99, P<0.001, FIG. 2) than both flies selecting deionized water and flies not making any choice.

2.2.2 Laboratory Oviposition Experiments

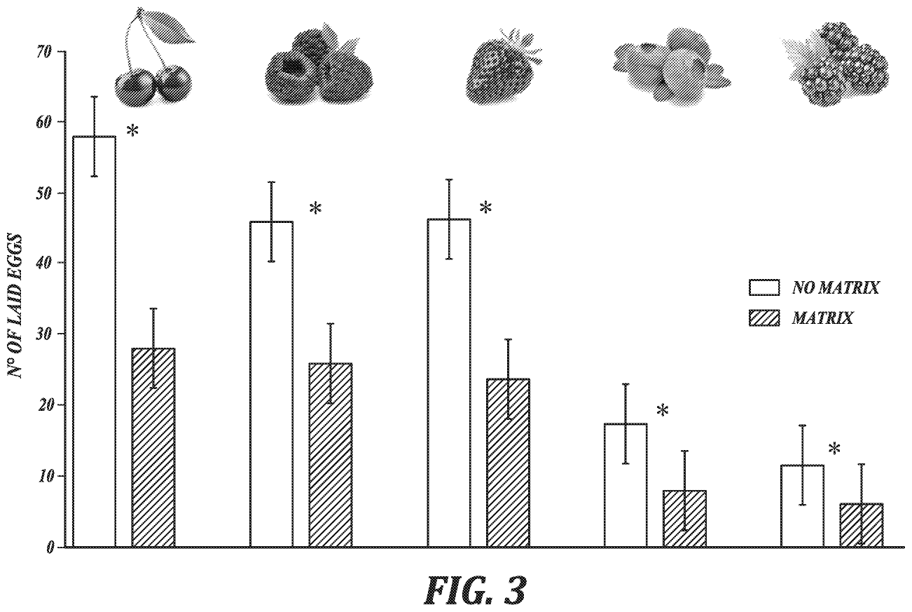

Overall, the presence of matrix resulted in a significant reduction in egg laying in all fruit types compared to untreated control treatments under controlled laboratory conditions (mean reduction=48.3%, F_{1, 98}=19.13, P<0.001 Table 2, FIG. 3). When flies were presented a choice between matrices and blackberries, a reduction of 46.5% of eggs in fruits compare to the control were recorded (F_{1, 19}=5.42, df=14.33, P=0.032) For blueberries, there was a reduction of 46.28% of eggs on fruits compared to the control (F_{1, 19}=32.27, df=17.98, P<0.001). For cherries, the choice test showed a reduction of 51.5% of eggs on fruits in the presence of the matrix compared to the control (F 1, 19=7.60, P=0.013). For raspberries there was a reduction of 43.5% (F_{1, 19}=13.73, df=14.09, P=0.002) and for strawberries there was a reduction of 48.5% (F_{1, 19}=12.93, df=17.58, P=0.002). Despite the statistical difference reported above, the numbers of eggs laid in fruit were statistically higher than in the matrices (F_{1, 98}=32.85, P<0.001), with 18.54±2.0 eggs in fruit compared to 5.02±1.2 eggs in the matrices. The freeze-dried D. suzukii powder addition to the original recipe resulted in a significant reduction in D. suzukii egg-laying in blueberry fruit (˜12% reduction in egg laying, F_{2, 34}=4.21, P<0.023).

2.2.3 Field Oviposition Trials

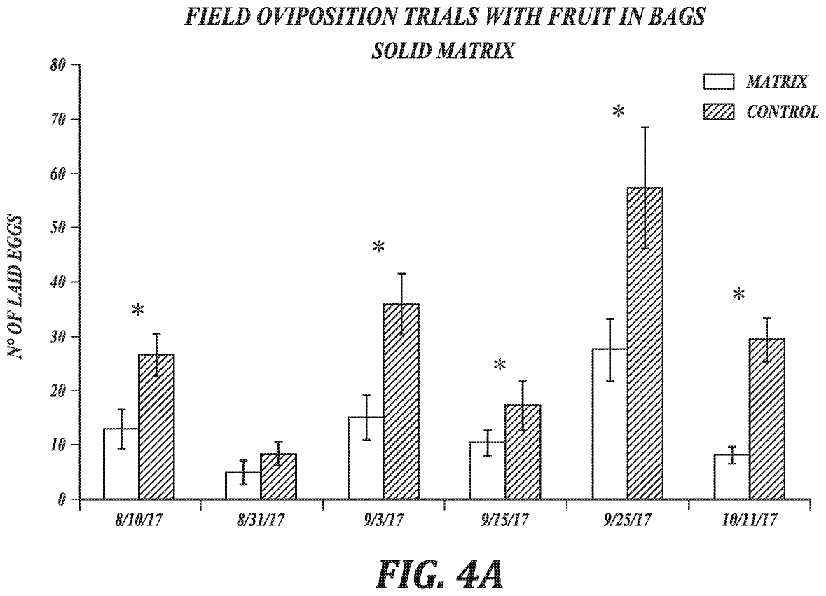

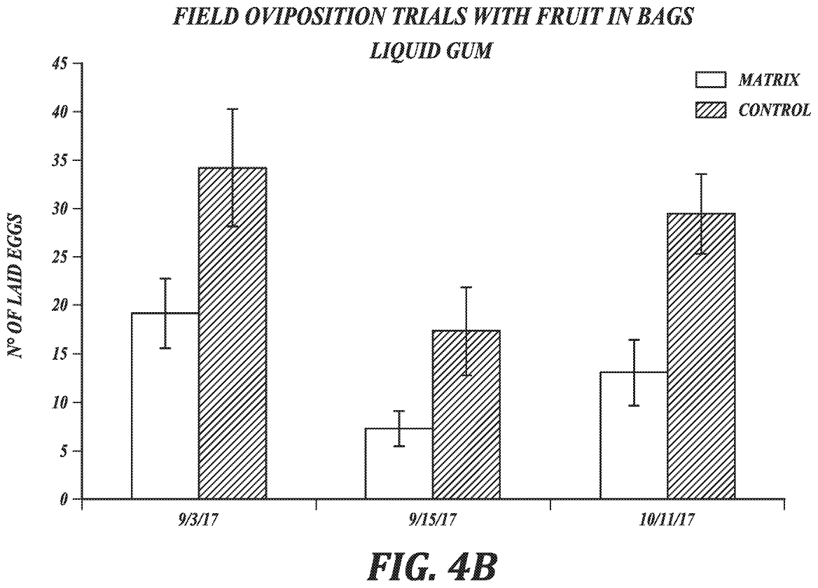

Field experiments using mesh bags to cover branches containing fruit indicated a consistent reduction of eggs laid using both solid and liquid versions of the matrix, with an overall reduction of eggs laid on fruits of 51.2% (F_{1, 99}=20.76, P<0.001). The fruit exposed to D. suzukii in the mesh bag field experiments displayed a significant reduction of eggs laid on berries for the solid matrix formulation on 5 out of 6 of the dates when this formulation was trialed (Mean eggs in fruit in absence of the matrices=28.7±3.7, Mean eggs in fruit in presence of the solid matrices=14±1.7, F_{1, 99}=20.76, P<0.001, FIG. 4A). The reduction of oviposition ranged from 41.5 to 72.2% during the D. suzukii exposure periods, which ranged from 72 to 96±2 hours. On 31 Aug. 2017, the reduction of egg-laying was not statistically significant at 41.5% reduction in egg laying.

The fruit exposed to D. suzukii in the mesh bag field experiments displayed a significant reduction of eggs laid on berries for the liquid formulation on all 3 dates when this formulation was trialed (Mean eggs of control=26.8±3.7, Mean eggs of matrix treatments=13.2±3.0, F_{1, 53}=17.56, P<0.001, FIG. 4b). The reduction of egg-laying ranged from 43.8 to 58.1% over each of the ˜86 h exposure periods to D. suzukii.

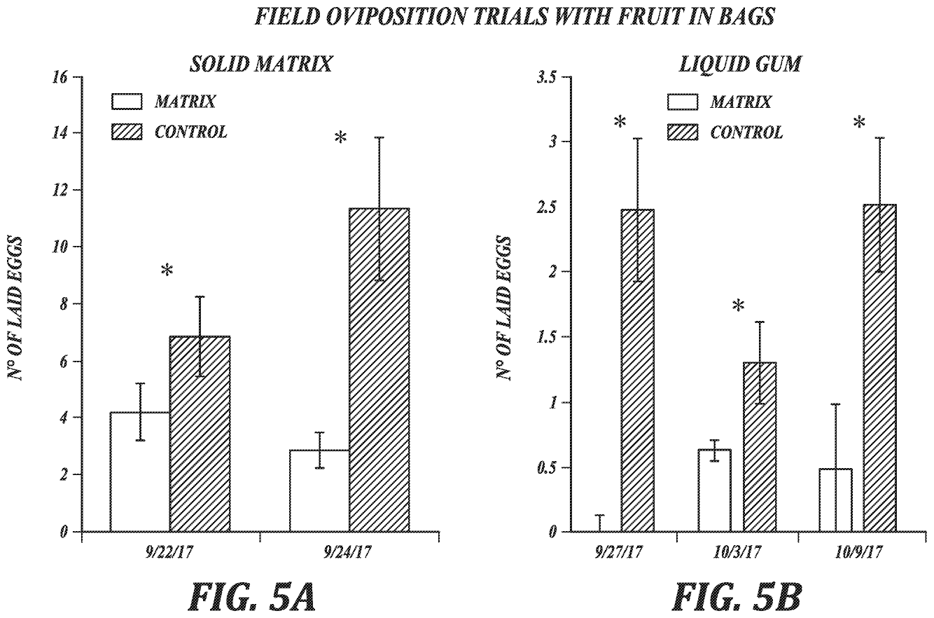

The whole-bush field experiments using the solid formulation resulted in a significant reduction (61.1%) of eggs laid on berries on both of the dates when this formulation was trialed (mean eggs of control=9.1±1.5, mean eggs of matrix treatments=3.5±0.6, F_{2, 47}=19.43, P<0.001, FIG. 5A). The reduction of egg-laying ranged from 39 to 75% over each of the 2˜86 h exposure periods to D. suzukii. For the whole-bush experiment using the liquid formulation, there was a significant reduction of 60.1% of eggs laid on berries on all the dates when this formulation was trialed (mean eggs control=9.1±1.5, mean eggs of matrix treatments=3.5±0.6, F_{2, 71}=15.46, P<0.001, FIG. 5B). The reduction of egg-laying ranged from 44 to 75% over each of the 3˜86 h exposure periods to D. suzukii.

When looking at the different locations in the blueberry bushes, egg-laying was impacted to the highest and lowest degree in the bottom, middle and upper portions of the bushes, on separate dates and overall (Tables 3, 4, 5, 6). Over all dates, the reductions in egg-laying in the bottom portion of the bushes were 60.9% (44.17% less infested fruit) and 56% (42.6%) infested fruit for the solid and liquid versions of the matrix treatments, respectively. The reduction in egg-laying within the middle portion of the bushes was 76.2% (59% less fruit infested) and 71.2% (59.8% less infested fruit) for the solid and liquid versions of the matrix treatments, respectively (Table 3, 5). Reductions in egg-laying in the upper portion of the bushes were 10% (25% less infested fruit) and 66.3% (73.3% less infested fruit) for the solid and liquid versions of the matrix treatments, respectively.

When looking at the most and least impacted locations in the blueberry bushes, combined with date, egg-laying was impacted to the highest and lowest degrees on 24 September and 22 September for the solid version of the matrices, respectively (Table 2). For the solid formulation, reductions of egg-laying in the middle portion of the bushes on these dates were 82.2% (71.5% less infested fruit) and 43.2% (46.5% less infested fruit), respectively (Table 3). Reduction in egg laying in the upper portions of the bushes on 24 September was 40% (40% reduction in fruit infestation). On 22 September there was no reduction in egg numbers, although 15% less fruit contained eggs (Table 2). On this day in the upper portion of the bush, there were 15% more eggs laid in the matrix treatment.

Oviposition was impacted to the highest and lowest degree on 2 and 9 October, respectively, for the liquid version of the matrices (Table 4). For the liquid version, reductions in egg-laying in the middle portion of the bushes on these dates were 76.1% (68.8% less infested fruit) and 28.2% (41.5% less infested fruit), respectively (Table 5). Reductions in egg-laying in the upper portions of the bushes on these dates were 86.9% (67.8% reduction in fruit infestation) and 82.9% (84% less infested fruit), respectively (Table 5).

2.2.4 Weather Data

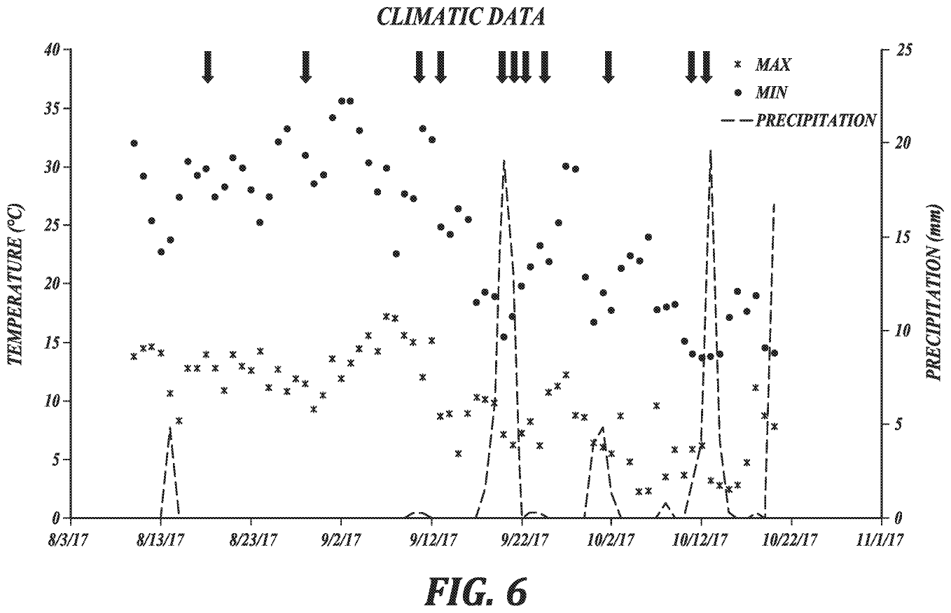

The temperature, humidity and precipitation from 15 August to 15 October varied significantly during the respective trial events. The days during which the field experiments were performed are indicated (FIG. 6). The hottest day with the lowest humidity on which experiments were conducted occurred on 1 September, (Tₘₐₓ 34.2° C., mean 49.5% relative humidity) with no precipitation recorded. The coldest day with the highest humidity on which experiments were conducted occurred on 12 October, (Tₘₐₓ 13.7° C., a mean of 91.3% relative humidity) with 18.9 mm precipitation. It appears as if the varying weather conditions played a minimal role in the efficacy of the treatments. Generally, it appeared as if more eggs were laid by D. suzukii during periods when temperatures were below 30° C. and above 20° C.

TABLE 2
Mean number of D. suzukii eggs in control compared to berries with liquid
formulation. Laboratory oviposition experiments included a choice test between a water
control and fruit type within an inverted modified 2-L plastic beaker. Numbers of
deposited eggs were recorded after 24 hours of exposure to D. suzukii

| | Eggs in control | Eggs in fruit | | Eggs in the |
|---|---|---|---|---|
| | fruit | with matrix | | matrix |
| Fruit type | (±SEM) | (±SEM) | P-Value | (±SEM) |
| Blackberries | 11.6 ± 2.0 | 6.2 ± 1.2 | 0.032 | 0 ± 0 |
| Blueberries | 17.2 ± 1.1 | 8.4 ± 1.1 | <0.001 | 11.8 ± 3.12 |
| Cherries | 58.1 ± 8.9 | 28.2 ± 6.2 | 0.013 | 2 ± 0.66 |
| Raspberries | 46 ± 4.7 | 26 ± 2.6 | 0.002 | 10.2 ± 3.82 |
| Strawberries | 46.4 ± 4.8 | 23.9 ± 4.1 | 0.002 | 1.1 ± 0.48 |

TABLE 3
Impact of date, solid matrix treatment and location in the blueberry bush on the
mean number of eggs laid by D. suzukii in field trials conducted in Corvallis, Oregon
on ‘Elliott’ blueberry on 22 and 24 Sep. 2017. Treated bushes received treatment as
opposed to control bushes, which did not receive the substrate

| | | | Mean eggs per | | Mean number | | |
|---|---|---|---|---|---|---|---|
| | | Bush | berry | | infested fruit | | |
| Date | Treatment | location | (± SEM) | P-value | (± SEM) | P-value | N |
| Sep. 22, 2017 | Control | Bottom | 9.2 ± 0.8 | 0.948 | 6.6 ± 1.1 | 0.089 | 5 |
| | Treatment | | 5.4 ± 1.5 | | 3.8 ± 0.9 | | |
| | Control | Middle | 10.2 ± 2.7 | 0.872 | 6.2 ± 1.8 | 0.274 | 5 |
| | Treatment | | 5.8 ± 2.2 | | 3.3 ± 0.9 | | |
| | Control | Top | 1.2 ± 0.6 | 1.00 | 1.4 ± 1.51 | 0.828 | 5 |
| | Treatment | | 1.4 ± 0.7 | | 1.2 ± 0.6 | | |
| Sep. 24, 2017 | Control | Bottom | 18.4 ± 4.1 | <0.001 | 10.6 ± 1.4 | 0.007 | 5 |
| | Treatment | | 5.4 ± 0.5 | | 5.2 ± 0.6 | | |
| | Control | Middle | 14.6 ± 2.7 | 0.002 | 8.4 ± 0.6 | <0.001 | 5 |
| | Treatment | | 2.6 ± 0.9 | | 2.4 ± 0.8 | | |
| | Control | Top | 1 ± 0.6 | 1.00 | 1 ± 0.6 | 0.607 | 5 |
| | Treatment | | 0.6 ± 0.4 | | 0.6 ± 0.4 | | |

TABLE 4
Overall impact of solid matrix treatment and location within
the blueberry bushes on the mean number of eggs laid by
D. suzukii in field trials conducted in Corvallis, Oregon on ‘'Elliott’
blueberry on 22 and 24 Sep. 2017. Treated bushes received treatment
as opposed to control bushes, which did not receive the substrate

| | | Mean eggs | | Mean number | | |
|---|---|---|---|---|---|---|
| | Bush | per berry | | infested fruit | | |
| Treatment | location | (± SEM) | P-value | (± SEM) | P-value | N |
| Control | Bottom | 13.8 ± 2.5 | 0.004 | 8.1 ± 1.1 | 0.003 | 10 |
| Treatment | | 5.4 ± 0.8 | | 4.5 ± 0.6 | | |
| Control | Middle | 12.4 ± 1.9 | 0.002 | 7.3 ± 1 | 0.002 | 10 |
| Treatment | | 4.2 ± 1.2 | | 3 ± 0.8 | | |
| Control | Top | 1.1 ± 0.4 | 0.862 | 1.2 ± 0.4 | 0.600 | 10 |
| Treatment | | 1 ± 0.4 | | 0.9 ± 0.3 | | |

TABLE 5
Impact of date, liquid treatment and bush location in the blueberry bush on the
number of eggs laid by D. suzukii in field trials conducted in Corvallis, Oregon on
‘Elliott’ blueberry on 28 Sep., 2 Oct., and 9 Oct. 2017. Treated bushes received
treatment as opposed to control bushes, which did not receive the substrate

| | | | Mean eggs | | Mean number | | |
|---|---|---|---|---|---|---|---|
| | | Bush | per berry | P- | infested fruit (± | | |
| Date | Treatment | location | (± SEM) | value | SEM) | P-value | N |
| Sep. 28, 2017 | Control | Bottom | 18.4 ± 4.1 | 0.010 | 10.6 ± 1.4 | 0.007 | 5 |
| | Treatment | | 5.4 ± 0.5 | | 5.2 ± 0.6 | | |
| | Control | Middle | 14.6 ± 2.7 | 0.003 | 8.4 ± 0.6 | <0.001 | 5 |
| | Treatment | | 5.4 ± 1.14 | | 2.4 ± 0.8 | | |
| | Control | Top | 1 ± 0.6 | 0.607 | 1 ± 0.6 | 0.607 | 5 |
| | Treatment | | 0.6 ± 0.4 | | 0.6 ± 0.4 | | |
| Oct. 2, 2017 | Control | Bottom | 6.6 ± 3.6 | 0.378 | 3.8 ± 1.6 | 0.636 | 5 |
| | Treatment | | 3.2 ± 0.4 | | 3 ± 0.3 | | |
| | Control | Middle | 9.2 ± 0.9 | <0.001 | 6.2 ± 0.7 | 0.003 | 5 |
| | Treatment | | 2.2 ± 0.7 | | 2 ± 0.7 | | |
| | Control | Top | 2 ± 0.9 | 0.191 | 1.6 ± 0.7 | 0.446 | 5 |
| | Treatment | | 1.2 ± 0.5 | | 1 ± 0.3 | | |
| Oct. 9, 2017 | Control | Bottom | 14.6.6 ± 4.3 | 0.362 | 8 ± 1.5 | 0.105 | 5 |
| | Treatment | | 8.8 ± 4.2 | | 4.6 ± 1.1 | | |
| | Control | Middle | 12.8 ± 4.2 | 0.604 | 8.2 ± 1.5 | 0.296 | 5 |
| | Treatment | | 9.2 ± 5.1 | | 4.8 ± 2.7 | | |
| | Control | Top | 7 ± 3.7 | 0.166 | 5 ± 2.4 | 0.126 | 5 |
| | Treatment | | 1.2 ± 0.7 | | 0.8 ± 0.4 | | |

TABLE 6
Overall impact of liquid treatment and location within the
blueberry bush on the number of eggs laid by D. suzukii in
field trials conducted in Corvallis, Oregon on ‘Elliott’ blueberry on
28 Sep., 2 Oct., and 9 Oct. 2017. Treated bushes received treatment
as opposed to control bushes, which did not receive the substrate

| | | Mean eggs | | Mean number | | |
|---|---|---|---|---|---|---|
| | Bush | per berry | | infested fruit | | |
| Treatment | Location | (± SEM) | P-value | (± SEM) | P-value | N |
| Control | Bottom | 13.2 ± 1.1 | 0.016 | 7.5 ± 1.1 | 0.012 | 15 |
| Treatment | | 5.8 ± 0.5 | | 4.3 ± 0.5 | | |
| Control | Middle | 12.2 ± 0.6 | 0.005 | 7.6 ± 0.6 | <0.001 | 15 |
| Treatment | | 4.7 ± 0.9 | | 3.1 ± 0.9 | | |
| Control | Top | 3.3 ± 0.9 | 0.113 | 2.5 ± 0.9 | 0.079 | 15 |
| Treatment | | 1 ± 0.2 | | 0.8 ± 0.2 | | |

3. Insect Control Compositions Comprising a Volatile Compound Component

In embodiments, insect control agents of the present disclosure comprise a volatile compound component.

3.1 Materials and Methods

3.1.1 GC-MS Analysis

The exemplary insect control composition was analyzed by GC-MS. Chromatographic analyses were carried out with a Trace GC Ultra gas chromatograph (Thermo Electron Corporation, Waltham, Mass., USA) coupled with a TSQ Quantum XLS Tandem mass spectrometer (Thermo Electron Corporation, Waltham, Mass., USA) and equipped with a PAL Combi-xt autosampler (CTC Analytics AG, Switzerland). The separation module consisted of a VFWaxms PEG capillary column (30 m×0.25 mm inner diameter×0.25 μm film thickness; Agilent J&W) programmed to increase from 60° C. (held for 3 min) at 8° C. min⁻¹ to 220° C. (held for 10 minutes) and, finally, to 250° C. at 10° C. min⁻¹ for 5 min. Helium was the carrier gas at a flow-rate of 1.2 mL min⁻¹. The temperature of the transfer line was 250° C. The electron impact energy was 70 eV and the filament current was 50 μA. The eluted compounds were identified by comparison with synthetic standards, considering their GC retention indices and with mass spectra using Wiley and the NIST Mass Spectral Library.

3.2 Results

3.2.1 Volatile Compounds

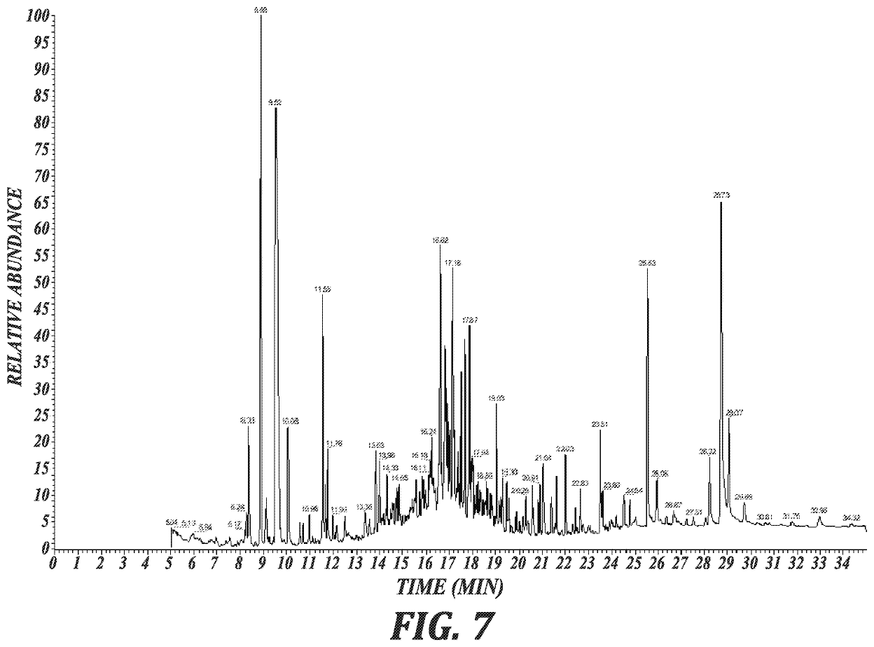

The GC-MS analysis of the exemplary insect control composition revealed the presence of several peaks. A representative GC-MS trace is shown in FIG. 7. The following table identifies the volatile compounds present in the exemplary insect control composition.

TABLE 7
Volatile compounds identified in the exemplary insect control
composition (RT is retention time)

| RT | Compound |
|---|---|
| 5.08 | 2-hexenal |
| 6.68 | benzene, 1,3,5-trimethyl |
| 8.24 | 1-octen-3-ol |
| 8.35 | acetic acid |
| 8.71 | methyl palmitate |
| 8.88 | 1-hexanol, 2-hetyl |
| 9.08 | decanal |
| 9.10 | trans-2-ethyl-2-hexan-l-ol |
| 9.41 | 7-methyl-z-tetradecen-l-ol acetate |
| 9.48 | benzaldehyde |
| 9.52 | benzaldeyde |
| 9.64 | propanoic acid |
| 10.07 | 1-methylpropanoic acid |
| 10.55 | hexadecane |
| 10.56 | heptadecane, 2,6,10,15-tetramethyl |
| 10.57 | heptadecane |
| 10.70 | cyclohexanone, 2-hydroxy |
| 10.97 | butyric acid |
| 11.56 | methylbutyric acid |
| 11.59 | butanoic acid, 3-methyl |
| 11.64 | 3-hexen-l-ol, 2,5-dimethyl, formate (z) |
| 11.69 | cyclohexane, isothiocyanato |
| 11.75 | salicylaldehyde |
| 11.76 | benzaldehyde, 2-hydroxy |
| 11.79 | salicilaldeide |
| 11.97 | tetradecane |
| 11.99 | heneicosane |
| 12.54 | pentanoic acid |
| 13.11 | methyl salicylate |
| 13.35 | octadecane, 1-chloro |
| 13.80 | isopropyl laurate |
| 13.84 | ethanone, 1-(3,4-dimethylphenyl) |
| 13.85 | ethanone, 1-(3,4-dimethylpenthyl) |
| 13.96 | kaurene |
| 13.97 | myristic acid |
| 13.99 | hexanoic acid |
| 14.33 | acethyl-m-xylene |
| 14.41 | benzyl alchol |
| 15.14 | methyl laurate |
| 15.38 | heptanoic acid |
| 15.47 | benzosulfonazole |
| 15.97 | isochiapin β |
| 16.00 | docosane |
| 16.45 | isopropyl dodecanoate |
| 16.61 | (+) cembrene |
| 16.70 | octanoic acid |
| 17.00 | triacetin |
| 17.10 | methyl myristate |
| 17.22 | dotriacontane |
| 17.50 | acetonanyl |
| 17.97 | pentadecanoic acid |
| 18.08 | geranyl α terpinene |
| 18.40 | tritriacontane |
| 19.05 | geranyl-p-cymene |
| 19.10 | 2,3-dihydroxypropyl palmitate |
| 16.16 | decanoic acid |
| 19.17 | dodecanoic acid |
| 19.23 | 1-hexadecanol, 2-methyl |
| 19.50 | octacosane |
| 19.51 | heptacosane |
| 19.53 | hentriacontane |
| 20.28 | octadecanoic acid |
| 20.30 | methylhexadecan-1 |
| 20.32 | heptadecanol |
| 20.62 | celidoniol, deoxy |
| 22.03 | phthalic acid |
| 22.42 | 1-heneicosanol |
| 22.63 | pentatriacontane |
| 23.75 | palmitoglycerol |
| 24.55 | tetratetracontate |
| 24.82 | bis (2-ethylhexyl) adipate |
| 25.53 | 2,3-dihyroxypropyl palmitate |
| 25.59 | palmitic acid |
| 25.95 | palmitoleic acid |
| 26.75 | pentacosane |
| 28.23 | octadecanoic acid |
| 28.25 | tearic acid |
| 28.26 | estradiol, 3-deoxy |
| 28.74 | cis, 13-octadecenoic acid |
| 28.73 | cis-13-octadecenoic acid |
| 28.77 | trans-13-octadecenoic acid |
| 29.08 | phthalic acid, bis (2-ethylhexyl) ester |
| 29.13 | 1,2-benzenedicarboxylic acid, 1,2-bis (2-ethylhexyl) ester |
| 29.18 | dioctyl phtalate |
| 31.32 | 13-docosenamide |
| 31.45 | erueylamide |
| 31.86 | dotriaconate |

While illustrative embodiments have been illustrated and described, it will be appreciated that various changes can be made therein without departing from the spirit and scope of the invention.

The embodiments of the invention in which an exclusive property or privilege is claimed are defined as follows:

1. A composition for control of Drosophila suzukii comprising:
(a) a cherry-derived component,
(b) arabinogalactan,
(c) thiamine, and
(d) a humectant.

2. The composition of claim 1, wherein arabinogalactan is larch tree arabinogalactan.

3. The composition of claim 1, wherein the cherry-derived component is freeze-dried cherry powder or fresh cherry.

4. The composition of claim 1, wherein the cherry-derived component comprises exocarp, cherry mesocarp, or a combination thereof.

5. The composition of claim 1, wherein the composition comprises cherry-derived component in the amount of between 0.1 wt % and about 99 wt %, between about 0.5 wt % and about 90 wt %, between about 10 wt % and about 90 wt %, %, between about 40 wt % and about 80 wt %, or between about 50 wt % and about 70 wt % on dry weight basis.

6. The composition of claim 1, wherein the composition comprises arabinogalactan in the amount of between about 0.1 wt % and about 99 wt %, between about 5 wt % and about 80 wt %, or between about 10 wt % and about 60 wt % on dry weight basis.

7. The composition of claim 1, wherein the composition comprises thiamine in the amount of between about 0.001 wt % and about 99 wt %, between about 0.1 wt % and about 50 wt %, or between about 0.5 wt % and about 10 wt % on dry weight basis.

8. The composition of claim 1, wherein the humectant is hyaluronic acid, alginic acid, collagen, calcium chloride, egg white, egg yolk, gelatin, glycerol, triacetin, glycerol acetates, lecithin, pyrrolidone carbonic acid, sorbitol, xylitol, mannitol, maltitol, honey, caramelized sucrose, propylene glycol, sodium lactate, glycerin betaine, trehalose, sodium stearoyl lactate, or a combination thereof.

9. The composition of claim 1, wherein the composition further comprises one or more components selected from collagen, beta-cyclodextrin, carrageenan, agar, calcium acetate, and calcium propionate.

10. The composition of claim 1, wherein the composition comprises dried cherry powder, arabinogalactan, thiamine, hyaluronic acid, collagen, beta-cyclodextrin, carrageenan, agar, calcium acetate, and calcium propionate.

11. The composition of any one of claims 1-10, wherein the composition further comprises dried D. suzukii insect powder.

12. The composition of any one of claims 1-10, wherein the composition further comprises isopropyl dodecanoate, isopropyl tetradecanoate, 1,2,3-propanetriol triacetate, methyl dodecanoate, methyl tetradecanoate, myristic acid, lauric acid, methyl hexadecanoate, palmitic acid, palmitoleic acid, or a combination thereof.

13. The composition of any one of claims 1-12, wherein the composition attracts male and female D. suzukii.

14. The composition of any one of claims 1-12, wherein the composition does not contain a pesticide.

15. The composition of any one of claims 1-12, wherein the composition is an aqueous composition or a dry powder.

16. The composition of claim 13, wherein the aqueous composition is a solution, a suspension, a gel, or a gum.

17. A method of controlling D. suzukii, comprising treating an object or an area with an effective amount of a D. suzukii control composition of any one of claims 1 16.

18. The method of claim 17, wherein the treated area is a non-fruiting base of a plant.

19. The method of claim 18, wherein the plant is a member of Vaccinium spp., Rubus spp., Vitis spp., Fragaria spp., or Prunus spp.

20. The method of claim 18 or claim 19, wherein the plant is a blueberry plant, huckleberry plant, raspberry plant, blackberry plant, strawberry plant, grape plant, or cherry plant.

21. The method of claim 17, wherein the treatment results in greater than about 35%, greater than about 40%, greater than about 50%, greater than about 60%, greater than about 70%, or greater than about 75% reduction in D. suzukii egg laying as determined by field oviposition trials on Elliott blueberries.

22. A composition for control of Drosophila suzukii comprising a volatile compound component comprising methyl myristate, myristic acid, lauric acid, methyl palmitate, palmitic acid, and palmitoleic acid.

23. The composition of claim 22, wherein the volatile compound component comprises from about 20 wt % to about 65 wt % palmitic acid, from about 20 wt % to about 65 wt % palmitoleic acid, from about 7 wt % to about 25 wt % myristic acid, from about 0.01 wt % to about 1.0 wt % lauric acid, from about 0.01 wt % to about 1.0 wt % methyl palmitate, and from about 0.01 wt % to about 1.0 wt % methyl myristate.

24. The composition of claim 22, wherein the volatile compound component comprises about 43.10 wt % palmitic acid, about 41.11 wt % palmitoleic acid, about 14.74 wt % myristic acid, about 0.66 wt % lauric acid, about 0.32 wt % methyl palmitate and about 0.07% methyl myristate.

25. The composition of any one of claims 22-24, further comprising a food grade matrix.

26. The composition of claim 25 wherein the food-grade matrix comprises a cherry-derived component.

27. The composition of claim 25 or claim 26, wherein the food grade matrix comprises arabinogalactan, thiamine, humectant, or a combination thereof.

28. The composition of claim 26, wherein the cherry-derived component is freeze-dried cherry powder or fresh cherry.

29. The composition of any one of claims 22-24, wherein the composition further comprises dried cherry powder, arabinogalactan, thiamine, hyaluronic acid, collagen, beta-cyclodextrin, carrageenan, agar, calcium acetate, and calcium propionate.

30. The composition of claim 29, wherein the composition further comprises dried D. suzukii powder.

31. The composition of any one of claims 22-30, wherein the composition does not contain a pesticide.

32. A method of controlling D. suzukii, comprising treating an object or an area with an effective amount of a D. suzukii control composition of any one of claims 22-31.

33. The method of claim 32, wherein the treated area is a non-fruiting base of a plant.

34. The method of claim 32, wherein the plant is a member of Vaccinium spp., Rubus spp., Vitis spp., Fragaria spp., or Prunus spp.

35. The method of claim 32, wherein the plant is a blueberry plant, huckleberry plant, raspberry plant, blackberry plant, strawberry plant, grape plant, or cherry plant.
